(19) United States
(12) Patent Application Publication
(10) Pub. No.: US 2009/0113428 A1
(43) Pub. Date: Apr. 30, 2009

(54) METHOD AND APPARATUS FOR FACILITATING A LOCATION-BASED, DISTRIBUTED TO-DO LIST

(75) Inventors: Gerald B. Huff, Mountain View, CA (US); Desiree Gosby, San Francisco, CA (US); Anna M. Simmons, Norton, MA (US); Matt E. Hart, Lunenburg, MA (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 11/932,547

(22) Filed: Oct. 31, 2007

(51) Int. Cl. G06F 9/46

(52) U.S. Cl. 718/100

(57) ABSTRACT

One embodiment of the present invention provides a system that facilitates a location-based, distributed to-do list. During operation, the system receives a request at a task-management system to create a task, wherein the request specifies a location for the task and an assignee for the task. In response to the request, the system creates the task. Next, the system receives a status update at the task management system, wherein the status update indicates a location of the assignee. Finally, when the location of the assignee substantially matches the location for the task, the system sends the task to the assignee.

### BACKGROUND

1. Field of the Invention

The present invention relates to task management systems. More specifically, the present invention relates to a method and an apparatus for facilitating a location-based, distributed to-do list.

2. Related Art

In order to efficiently manage hectic lifestyles, many people use Personal Digital Assistants (PDAs) to keep track of appointments, contacts, and tasks. Typically, as these individuals receive tasks, or remember things that they need to complete, they create entries for tasks in their task list. However, in order for this task list to be effective, users must review their task list regularly, or they must set reminders for a specific time when they would like to be reminded of a particular task.

When an individual is faced with a large number of tasks, a traditional task list can quickly become ineffective. For example, some tasks may be buried in the large list of tasks, and may not be seen at the opportune time to complete the task. Furthermore, if the task is delegated to another person, unless the other person effectively manages their tasks, the task might not be completed.

Some existing systems allow an individual to create and assign tasks to other individuals; however, these systems still require that the other individuals actively monitor and manage their individual task lists. Furthermore, often it is unclear who to assign a task to. For example, if a computer server needs to be rebooted as soon as possible, with most existing systems it is desirable to create a task to reboot the server for every member of a technical support staff that has access to the server. However, this can cause further problems because it is undesirable to reboot the server after it has already been rebooted the first time.

### SUMMARY

One embodiment of the present invention provides a system that facilitates a location-based, distributed to-do list. During operation, the system receives a request at a task-management system to create a task, wherein the request specifies a location for the task and an assignee for the task. In response to the request, the system creates the task. Next, the system receives a status update at the task management system, wherein the status update indicates a location of the assignee. Finally, when the location of the assignee substantially matches the location for the task, the system sends the task to the assignee.

In some embodiments of the present invention, receiving the request to create the task can involve receiving the request via one of: a voice call, an email, a text message, an instant message, a web interface, or a client interface.

In some embodiments of the present invention, sending the task to the assignee can involve sending the task via one of: a voice call, an email, an instant message, a text or an alpha-numeric page, or a text message.

In some embodiments of the present invention, the system determines the location of the assignee by one of: a Global Positioning System (GPS) device, a cell-phone network triangulation, a wireless Personal Area Network (PAN) activity (such as Bluetooth™), or a Wi-Fi hotspot activity.

In some embodiments of the present invention, the assignee is one of an individual or a group of individuals.

In some embodiments of the present invention, the system consolidates multiple tasks which are associated with the same location into a consolidated task.

In some embodiments of the present invention, the location of the task is specified as a location category, which is associated with multiple matching locations that belong to the category.

In some embodiments of the present invention, sending the task to the assignee involves sending the task to the assignee when the assignee is within a pre-determined distance of the location.

In some embodiments of the present invention, the request includes a target time, wherein the task is sent to assignee on or after the target time.

In some embodiments of the present invention, the request includes an event, wherein the task is sent to assignee upon or after a start or a completion of the event.

### BRIEF DESCRIPTION OF THE FIGURES

FIG. 1 illustrates a computing environment in accordance with an embodiment of the present invention.

FIG. 2 presents a flowchart illustrating the process of creating a task in accordance with an embodiment of the present invention.

FIG. 3 presents a flowchart illustrating the process of performing a location-based notification in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

One embodiment of the present invention provides a system that facilitates a location-based, distributed to-do list. During operation, the system receives a request at a task-management system to create a task, wherein the request specifies a location for the task and an assignee for the task. In response to the request, the system creates the task. Next, the system receives a status update at the task management system, wherein the status update indicates a location of the assignee. Finally, when the location of the assignee substantially matches the location for the task, the system sends the task to the assignee.

For example, consider the situation where a user may wish to create a task to purchase some eggs the next time the user is at the grocery store. The user could simply call up a service and say “remind me to buy eggs at the grocery store.” In this example, the system would then create a task assigned to the user reminding the user to buy eggs. This task would then be delivered to the user via a method of the user's choice the next time the user visits the grocery store. For example, when the user enters the grocery store, the user may receive an automated phone call or a Simple Message Service (SMS) message on the user's phone reminding the user to buy eggs.

Note that locations can come from various sources, such as the user's personal information (such as “home” or “work”), as well as publicly available geographic and/or business data (such as “Chicago” or “McDonald's”).

In some embodiments of the present invention, the request takes the following form: remind [assignee] [task message] at [time][location]

In some embodiments of the present invention, receiving the request to create the task can involve receiving the request via one of: a voice call, an email, a text message, an instant message, a web interface, or a client interface.

Various embodiments of the present invention allow for any type of input into the system. Some systems may support input via a voice call with a voice-recognition system, while others may support email inputs, while still others may support any combination of available methods. In some embodiments of the present invention, the system is integrated directly into the user's personal information manager, such as Microsoft® Outlook® or Apple Mail.

In some embodiments of the present invention, sending the task to the assignee can involve sending the task via one of: a voice call, an email, an instant message, a text or an alpha-numeric page, or a text message.

Note that the system may notify the assignee via multiple methods simultaneously, or may notify the assignee via an alternative method if the assignee does not acknowledge receipt of the task via the first method. For example, if the system delivers the task to the assignee via an SMS message and the user does not confirm receipt with an SMS reply within a specified period of time, the system may call the assignee's cell phone via an automated calling service. Furthermore, note that in some embodiments of the present invention, these options are configurable by the user.

In some embodiments of the present invention, the system determines the location of the assignee by one of: a Global Positioning System (GPS) device, a cell-phone network triangulation, a wireless Personal Area Network (PAN) activity (such as Bluetooth™), or Wi-Fi hotspot activity. (Note that embodiments of the present invention are not meant to be limited to the techniques listed above for determining a location. Any location-determining technique may be used.) In doing so, the system may determine the location of the assignee from the assignee's cell phone, PDA, or any other mobile device the user might be carrying. In some embodiments of the present invention, the assignee may specify his or her current location. Note that in some embodiments of the present invention, the system may try to determine the assignee's location based on his or her calendar. For example, if the assignee has an appointment on his or her calendar with a specified location, the system might assume that the assignee is at the specified location during the appointment time.

In some embodiments of the present invention, the assignee is one of an individual or a group of individuals. For example, the assignee may be an entire technology support team rather than an individual. If a task is assigned to the technology support team and the task requests some hardware to be picked up at the corporate supply depot, the system may notify the first member of the technology support team that goes to the corporate supply depot to pick up the hardware. In this example, the other members of the technology support team are not burdened with the task notification.

In a variation on this embodiment, if the first member of the technology support team that goes to the corporate supply depot does not acknowledge the task, or declines the task, then the task is still active in the system until the next member of the technology support team visits the corporate supply depot.

In some embodiments of the present invention, the system consolidates multiple tasks which are associated with the same location into a consolidated task. For example, a user may create a task to buy eggs at the grocery store, and then subsequently create a task to buy milk at the grocery store. The next time the user goes grocery shopping, the system will send the user one task to buy both eggs and milk.

In some embodiments of the present invention, the location of the task is specified as a location category, which is associated with multiple matching locations that belong to the category. For example, the user may specify the location as “a hardware store” or “a shopping mall” rather than specifying a specific location. Categories can be very narrow, or extremely broad. For example, the category may be a “golf shop” or a “sporting goods store.”

In some embodiments of the present invention, sending the task to the assignee involves sending the task to the assignee when the assignee is within a pre-determined distance of the location. Rather than being notified when a user is at a specific location, the user may wish to be notified of a task when they are within a pre-determined range of the specific location. This is especially useful if the user is within range of a location often, but usually does not stop at or go to the specific location. For example, if the user needs to pick up a form at the Department of Motor Vehicles (DMV), then the user might specify to be notified when he or she comes within five blocks or within half of a mile of a DMV.

In some embodiments of the present invention, the request includes a target time, wherein the task is sent to assignee on or after the target time. For example, Bob may wish to assign himself a task to pick up a copy of the Sunday paper the next time he is near a news stand on or after Sunday morning.

In some embodiments of the present invention, the request includes an event, wherein the task is sent to assignee after the start or completion of the event. For example, Bob may wish to assign a task to Dan to instruct Dan to call Bob the next time Dan is in the office after a specific market order has been executed.

In some embodiments of the present invention, the system exposes Application Programming Interfaces (APIs) for the various interfaces so that the system may be extended to new technologies. For example, the system may have a location API that accepts input from any number of devices that can supply location information for an assignee, as well as a communication API that allows the system to communicate with devices that adhere to the communication API.

In some embodiments of the present invention, the system is integrated into an existing customer resource management system.

### Computing Environment

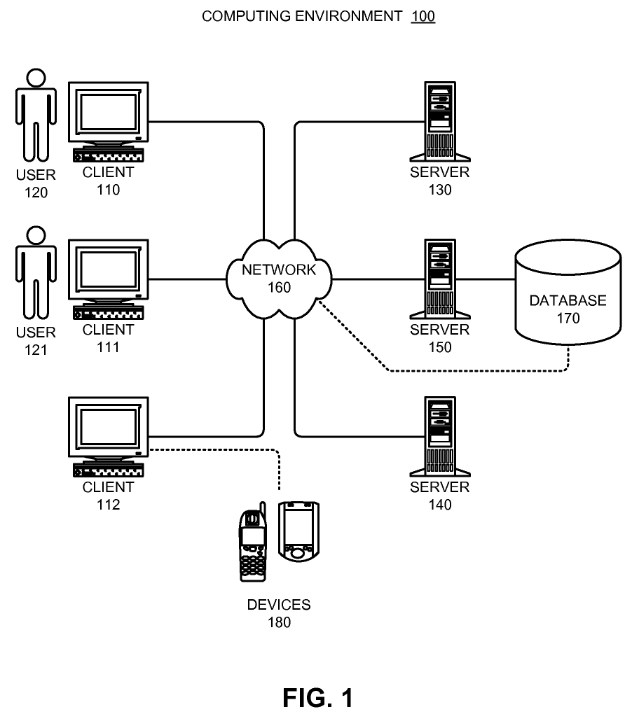

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120 and 121, servers 130-150, network 160, database 170, and devices 180.

Clients 110-112 can include any node on a network including computational capability and including a mechanism for communicating across the network.

Similarly, servers 130-150 can generally include any node on a network including a mechanism for servicing requests from a client for computational and/or data storage resources.

Users 120 and 121 can include: an individual; a group of individuals; an organization; a group of organizations; a computing system; a group of computing systems; or any other entity that can interact with computing environment 100.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

Database 170 can include any type of system for storing data in non-volatile storage. This includes, but is not limited to, systems based upon magnetic, optical, or magneto-optical storage devices, as well as storage devices based on flash memory and/or battery-backed up memory. Note that database 170 can be coupled: to a server (such as server 150), to a client, or directly to a network.

Devices 180 can include any type of electronic device that can be coupled to a client, such as client 112. This includes, but is not limited to, cell phones, Personal Digital Assistants (PDAs), smart-phones, personal music players (such as MP3 players), gaming systems, digital cameras, portable storage media, or any other device that can be coupled to the client. Note that in some embodiments of the present invention, devices 180 can be coupled directly to network 160 and can function in the same manner as clients 110-112.

Note that different embodiments of the present invention may use different configurations, and are not limited to the configuration illustrated in computing environment 100. In some embodiments of the present invention, the system is implemented as a web-service on server 150, while in other embodiments of the present invention, the system is implemented as an application executing on client 110. Also note the users 120-121 may access the system via various devices, such as via: clients 110-112, devices 130, or servers 130-150.

### Creating a Task

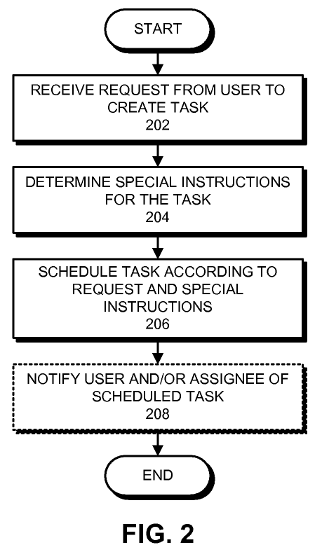

FIG. 2 presents a flowchart illustrating the process of creating a task in accordance with an embodiment of the present invention. During operation, the system receives a request from user 120 to create a task (operation 202). Note that the task should minimally specify an assignee and a time and/or a location. Next, the system should determine if any special instructions are included in the request, such as method of delivery (operation 204). Note that in some embodiments of the present invention, if no special instructions are included, the system may use system defaults and/or user-defined defaults for user 120 and/or the assignee.

Once the task request and any special instructions have been received, the system schedules the task according to the request and the special instructions (operation 206). In some embodiments of the present invention, the system may optionally notify user 120 and/or the assignee of the scheduling of a new task (operation 208).

Note that in some embodiments of the present invention, user 120 is provided with an interface where user 120 can review every task that user 120 has created. Furthermore, in some embodiments, user 120 may also see every task that is assigned to user 120. If user 120 is a member of a group, some embodiments allow user 120 to see all of the tasks assigned to the group, as well as to reassign group tasks to user 120. Rights to view specific information can be: defined by an administrator; defined in the task creation request; or defined in user preferences. Note that some embodiments of the present invention may be integrated into existing task-management systems that include advanced task-management and assignment features.

### Location-Based Notification

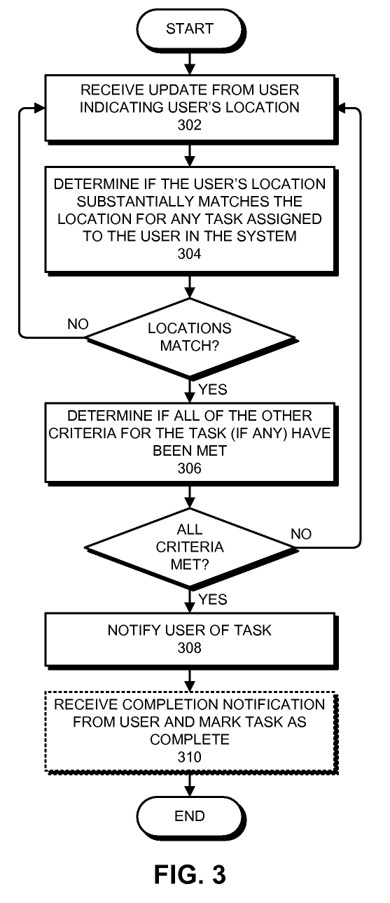

FIG. 3 presents a flowchart illustrating the process of performing a location-based notification in accordance with an embodiment of the present invention. During operation, the system receives updates from user 121 indicating user 121's location (operation 302). Note that any method for determining user 121's location may be used as described above.

Next, the system determines if user 121's location substantially matches the location for any task assigned to user 121 in the system (operation 304). If so, the system determines if all of the remaining criteria for the task (if any) have been met (operation 306). Note that this may include if a specific event has started or occurred, or if a specific time has passed.

If all of the criteria have been met, the system notifies user 121 of the task via one or more of the communication methods described above (operation 308).

In some embodiments of the present invention, the system receives a completion notification from user 121 indicating that the task has been completed; and in response to the notification, the system marks the task as complete (operation 310).

Note that in some embodiments of the present invention, the system may also notify user 120 that the task that user 120 assigned to user 121 has been completed. Receiving a completion notification may also prevent the system from assigning the task to another assignee.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for facilitating a location-based, distributed to-do list, the method comprising:
receiving a request at a task-management system to create a task, wherein the request specifies a location for the task and an assignee for the task;
in response to the request, creating the task;
receiving a status update at the task management system, wherein the status update indicates a location of the assignee; and
when the location of the assignee substantially matches the location for the task, sending the task to the assignee.

2. The method of claim 1, wherein receiving the request to create the task can involve receiving the request via one of:
a voice call;
an email;
a text message;
an instant message;
a web interface; or
a client interface.

3. The method of claim 1, wherein sending the task to the assignee can involve sending the task via one of:
a voice call;
an email;
an instant message;
a text or an alpha-numeric page; or
a text message.

4. The method of claim 1, further comprising determining the location of the assignee by one of:
a Global Positioning System (GPS) device;
a cell-phone network triangulation;
a wireless Personal Area Network (PAN) activity; or
a Wi-Fi hotspot activity.

5. The method of claim 1, wherein the assignee is one of an individual or a group of individuals.

6. The method of claim 1, further comprising consolidating multiple tasks which are associated with the same location into a consolidated task.

7. The method of claim 1, wherein the location of the task is specified as a location category, which is associated with multiple matching locations that belong to the category.

8. The method of claim 1, wherein sending the task to the assignee involves sending the task to the assignee when the assignee is within a pre-determined distance of the location.

9. The method of claim 1, wherein the request includes a target time, and wherein the task is sent to the assignee on or after the target time.

10. The method of claim 1, wherein the request includes an event, and wherein the task is sent to the assignee upon or after a start or a completion of the event.

11. A computer-readable storage medium storing instructions that when executed by a computer cause the computer to perform a method for facilitating a location-based, distributed to-do list, the method comprising:
receiving a request at a task-management system to create a task, wherein the request specifies a location for the task and an assignee for the task;
in response to the request, creating the task;
receiving a status update at the task management system, wherein the status update indicates a location of the assignee; and
when the location of the assignee substantially matches the location for the task, sending the task to the assignee.

12. The computer-readable storage medium of claim 11, wherein receiving the request to create the task can involve receiving the request via one of:
a voice call;
an email;
a text message;
an instant message;
a web interface; or
a client interface.

13. The computer-readable storage medium of claim 11, wherein sending the task to the assignee can involve sending the task via one of:
a voice call;
an email;
an instant message;
a text or an alpha-numeric page; or
a text message.

14. The computer-readable storage medium of claim 11, wherein the method further comprises determining the location of the assignee by one of:
a Global Positioning System (GPS) device;
a cell-phone network triangulation;
a wireless Personal Area Network (PAN) activity; or
a Wi-Fi hotspot activity.

15. The computer-readable storage medium of claim 11, wherein the assignee is one of an individual or a group of individuals.

16. The computer-readable storage medium of claim 11, wherein the method further comprises consolidating multiple tasks which are associated with the same location into a consolidated task.

17. The computer-readable storage medium of claim 11, wherein the location of the task is specified as a location category, which is associated with multiple matching locations that belong to the category.

18. The computer-readable storage medium of claim 11, wherein sending the task to the assignee involves sending the task to the assignee when the assignee is within a pre-determined distance of the location.

19. The computer-readable storage medium of claim 11, wherein the request includes a target time, and wherein the task is sent to the assignee on or after the target time.

20. The computer-readable storage medium of claim 11, wherein the request includes an event, and wherein the task is sent to the assignee upon or after a start or a completion of the event.

21. An apparatus configured to facilitate a location-based, distributed to-do list, comprising:
a receiving mechanism configured to receive a request at a task-management system to create a task, wherein the request specifies a location for the task and an assignee for the task;
a task-creation mechanism configured to create the task in response to the request;
wherein the receiving mechanism is further configured to receive a status update at the task management system, wherein the status update indicates a location of the assignee; and
a delivery mechanism configured to send the task to the assignee when the location of the assignee substantially matches the location for the task.
